(19) United States
(12) Patent Application Publication
(10) Pub. No.: US 2025/0012751 A1
(43) Pub. Date: Jan. 9, 2025

(54) MEASURING ELECTRO-CHEMICAL PROPERTIES OF FLOWABLE MATERIALS

(71) Applicant: UNIVERSITY OF PITTSBURGH - OF THE COMMONWEALTH SYSTEM OF HIGHER EDUCATION, Pittsburgh, PA (US)

(72) Inventors: Rebecca Nicole Segel, Newtown, PA (US); Christopher Eli Wilmer, Pittsburgh, PA (US); James R. McKone, Pittsburgh, PA (US)

(21) Appl. No.: 18/706,937

(22) PCT Filed: Nov. 10, 2022
(86) PCT No.: PCT/US2022/049518

§ 371 Date: May 2, 2024

Related U.S. Application Data
(60) Provisional application No. 63/277,758, filed on Nov. 10, 2021.

(51) Int. Cl. G01N 27/27; G01N 27/416; H01M 8/04537; H01M 8/18

(52) U.S. Cl. CPC G01N 27/27; G01N 27/416; H01M 8/04537; H01M 8/188

(57) ABSTRACT

The invention provides an integrated multi-channel battery analyzer including one or more measurement units and accompanying pluggable battery capsules that physically and electrically connect to the measurement unit(s) to obtain multiple measurements simultaneously of electro-chemical properties for flowable materials, e.g., flowable batteries. The battery capsules are in a stacked configuration and include electrical components, e.g., positive and negative electrodes, and positive and negative flow channels through which the positive and negative electrolyte travels, respectively, as well as a separator positioned between the flow channels, and at least one pump. In addition, the battery capsules have a small size as compared to battery capsules known in the art.

### CROSS REFERENCE TO RELATED APPLICATIONS

This application is a PCT application that claims priority to U.S. provisional patent application No. 63/277,758, entitled “INTEGRATED PLATFORM FOR MEASURING ELECTRO-CHEMICAL PROPERTIES OF FLOWABLE MATERIALS”, filed on Nov. 10, 2021, the contents of which are incorporated herein by reference.

### GOVERNMENT SUPPORT

This invention was made with government support under CBET2015859 awarded by the National Science Foundation. The government has certain rights in the invention.

### FIELD OF THE INVENTION

The invention relates to an integrated multi-channel battery analyzer and accompanying pluggable battery capsules, having the ability to run multiple measurements simultaneously of electro-chemical properties for flowable materials, e.g., flowable molecules of use for energy storage.

### BACKGROUND

Electrochemical diagnostic systems have the potential to provide full state of health analysis to battery systems to ensure a more reliable electric grid. In 2021, the Department of Energy (DOE) announced their goal to cut costs of long-duration energy storage (LDES) by 90% over the next decade, in line with a broader goal of eliminating carbon pollution from energy generation by 2035. LDES are systems that are capable of discharging energy for greater than ten hours at their rated power, which is a prerequisite for 100% clean electricity.

The most popular LDES solution is pumped hydro energy storage (PHES) which supplies 93% of utility-scale electric energy storage in the U.S. as of 2022. While effective for storing large amounts of energy, PHES alone is inadequate due to geographic and space requirements. In contrast, lithium ion batteries (LIBs) have been deployed in combination with renewable generation, but their high energy density is suitable for portable applications like automobiles and phones. Further, safety and supply-chain concerns limit their applicability in LDES where portability is unimportant. Flow batteries (FB) are especially suitable for LDES because of their advantageous properties when scaling. Because FBs store energy in flowable media, storing more energy only requires increasing the volume of the associated holding tanks. This results in markedly reduced costs to store electric energy as the duration increases, making FBs economically competitive for LDES.

A schematic of a conventional FB is shown in FIG. 1. The FB (1) has a stack (3) that includes two electrodes (5) separated by a separator (7). The stack (3) drives chemical reactions that constitute conversion of electric energy into chemical energy (charging) and vice-versa (discharging). Storage tanks (8) house the fluid or fluids that are responsible for storing energy. The pumps (9) convey electrolyte to and from the stack (3). Because the stack, tanks, and pumps are housed independently, scaling up a FB is as simple as adding more electrolyte. Typical FB designs are sized with a total volume about the size of a traditional shipping container, most of which is the storage tanks.

In commercial FBs, a significant difficulty is pinpointing points of failure—e.g., reduced rates of charge or discharge; reduced energy efficiency; parasitic electric current flow; or fluid leaks. There does not yet exist a technology that can provide comprehensive health insights for operational FBs. When properly implemented, FB diagnostics can uncover how operating conditions affect performance and how to optimize conditions for stability and large capacities. With improved performance efficiency and durability afforded by proper diagnostics, FBs can be housed alongside renewable energy generation sites to provide reliable renewable energy on demand.

There is a need in the art to provide technology for monitoring flow battery state of charge, localized current density, electrolyte concentration, and rates of parasitic processes, among others. There is also a need in the art for improved efficiency and fidelity in the discovery of new materials for use in FB fluid formulations and other active components. Robust diagnostics, continuous monitoring, and inexpensive materials are vital for improving scale-up, and improved standard configurations for testing are needed for FBs to be a mature technology.

### BRIEF DESCRIPTION OF THE DRAWINGS

FIG. 1 is a schematic that illustrates a conventional flow battery (FB) (1), in accordance with the prior art;

FIG. 2A is a schematic that illustrates a FB (1) and multiple portable flow capsules (12) strategically placed throughout the FB (1) to transmit data to a central control hub (13), in accordance with certain embodiments of the invention;

FIG. 2B is a schematic that illustrates a detail view of the portable flow capsules (12) as shown in FIG. 2A, in accordance with certain embodiments of the invention:

FIG. 2C is a schematic that illustrates a detail view of the components of the portable flow capsules (12) as shown in FIG. 2A, in accordance with certain embodiments of the invention;

FIG. 3 is a schematic that illustrates the multi-channel battery analyzer (14) of FIG. 2A having multiple pluggable flow capsules (18) connected to a measurement unit (16), in accordance with certain embodiments of the invention;

FIG. 4 is a schematic that illustrates a detail view of the pluggable flow capsules (18), in accordance with certain embodiments of the invention; and

FIG. 5 is a schematic that illustrates a detail view of the electrical components of the pluggable flow capsules (18), in accordance with certain embodiments of the invention.

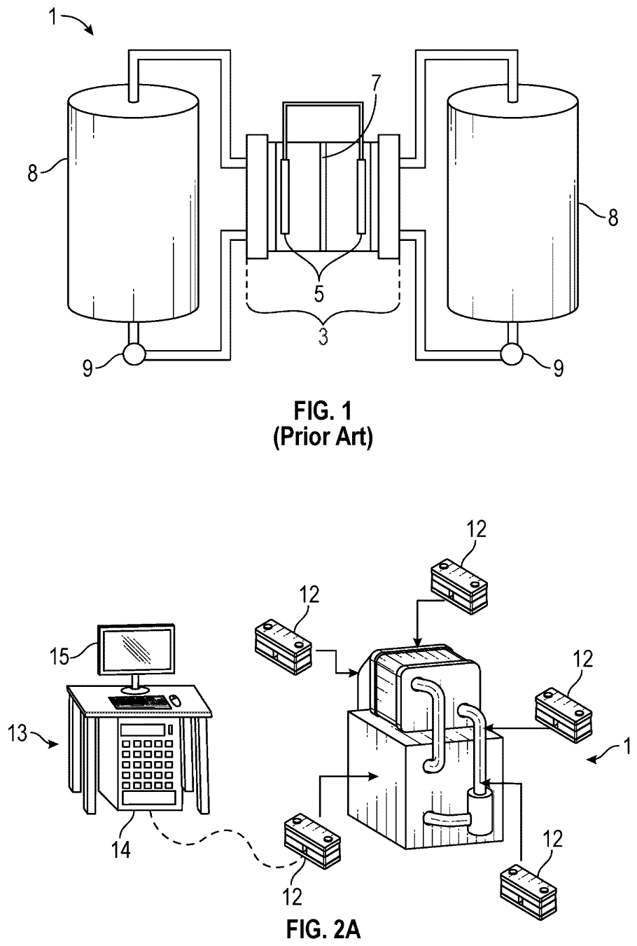

### SUMMARY OF THE INVENTION

In one aspect, the invention provides one or more flow capsules (12, 18), including a semi-permeable separator (27) having a first exterior side and a second exterior side; a first flow channel plate (26) having an interior wall, positioned in a stacked configuration along the first exterior side of the separator plate; (27) a second flow channel plate (28) having an interior wall, positioned in a stacked configuration along the second exterior side of the separator plate (27); and a first electrode plate (25) and second electrode plate (29) positioned correspondingly in a stacked configuration along the interior wall of each of the first and second flow channel plates (26, 28), respectively, wherein the first and second electrode plates (25, 27) inject or extract electric charge, and wherein the total internal volume of fluid contained or stored in the flow capsule (12, 18) is from about 0.1 mL to about 10 mL.

The one or more flow capsules (12, 18) can further include an outer casing to provide structure, wherein the casing can seal against an external environment.

The one or more flow capsules (12, 18) can further include at least one of a reservoir (24) and a pump (30).

In certain embodiments, the one or more flow capsules (12, 18) is structured to be disassembled and reassembled to replace one or more of the fluid, the first and second electrode plates (25, 29), and the semi-permeable separator (42).

In certain embodiments, the one or more flow capsules (12, 18) include a total volume of fluid from about 0.1 mL to about 1 mL, or total volume of fluid is about 1 mL.

In certain embodiments, the one or more flow capsules (12, 18) are structured to execute multiple analytical functions.

In certain embodiments, the one or more flow capsules (12, 18) are structured to correspondingly plug into multiple measurement units (16) to provide multiple measurements simultaneously.

The one or more flow capsules (12, 18) may have dimensions of 3 inch by 2 inch by 1 inch.

In another aspect the invention provides a method of obtaining multiple measurements simultaneously. The method includes employing an integrated multi-channel battery analyzer (14), comprising one or more measurement units (16); and connecting physically and electrically to the one or more measurement units, one or more pluggable flow capsules (18) being in a stacked configuration including a separator having an upper surface and a lower surface; a positive flow channel plate (26) having an upper surface and a lower surface, the lower surface of the positive flow channel connected to the upper surface of the separator plate (27); a negative flow channel plate (28) having an upper surface and a lower surface, the upper surface of the negative flow channel connected to the lower surface of the separator plate (27); and a positive electrode plate (25) having an upper surface and a lower surface, the lower surface of the positive electrode connected to the upper surface of the positive flow channel plate (26); and a negative electrode plate (29) having an upper surface and a lower surface, the upper surface of the negative electrode connected to the lower surface of the negative flow channel plate (28).

In another aspect the invention provides a method of measuring electro-chemical properties of a flow battery. The method includes obtaining a flow battery; strategically placing multiple portable flow capsules (12) throughout the flow battery; and transmitting data from the flow capsules (12) to a central control hub (13), including a computer (15); and a multi-channel battery analyzer (14); one or more measurement units (16); and the multiple portable flow capsules (12) being in a stacked configuration, including a separator (128, 130) having an upper surface and a lower surface; a positive flow channel (132) having an upper surface and a lower surface, the lower surface of the positive flow channel connected to the upper surface of the separator (130); a negative flow channel (126) having an upper surface and a lower surface, the upper surface of the negative flow channel connected to the lower surface of the separator (128); and a positive electrode (136) having an upper surface and a lower surface, the lower surface of the positive electrode connected to the upper surface of the positive flow channel (132); and a negative electrode (124) having an upper surface and a lower surface, the upper surface of the negative electrode connected to the lower surface of the negative flow channel (126), wherein the positive and negative electrodes inject and extract electric charge, respectively, and wherein, the computer (21) comprises software to control the one or more measurement units, provide high-throughput data analytics to pinpoint deficiencies and an analysis of the flow battery performance.

In another aspect the invention provides an integrated flow battery device, including one or more pluggable flow capsules (18), including a separator plate (27) having a first exterior side and a second exterior side; a first flow channel plate (26) having an interior wall, positioned in a stacked configuration along the first exterior side of the separator plate (27); a second flow channel (28) plate having an interior wall, positioned in a stacked configuration along the second exterior side of the separator plate (27); and a first electrode plate (25) and second electrode plate (29) positioned correspondingly in a stacked configuration along the interior wall of each of the first and second flow channel plates (26, 28), respectively, wherein the first and second electrode plates (25, 29) inject or extract electric charge, and wherein the internal volume of fluid contained or stored in the pluggable flow capsule (18) is from about 0.1 mL to about 10 mL; a multi-channel battery analyzer (14), including one or more measurement units (16) into which the one or more pluggable flow capsules (18) correspondingly connects physically and electrically; software (15) to control the one or more measurement units (16); and electrical components (32) to measure electrochemical properties; and a fluid accommodated by the first and second flow channels (26, 28) in the one or more pluggable flow capsules to accept and deliver the electric charge to an external circuit.

In certain embodiments, the electrochemical measurements include measurement and/or modulation of electric potential difference and electric current flow between electrodes in the one or more pluggable flow capsules (18).

In certain embodiments, the one or more pluggable flow capsules (18) when correspondingly plugged into the one or more measurement units (16), provide multiple measurements simultaneously.

In certain embodiments, the total internal volume of fluid of each of the one or more pluggable flow capsules (18) is from about 0.1 mL to about 1 mL, or about 1 mL.

### DETAILED DESCRIPTION OF THE PREFERRED EMBODIMENTS

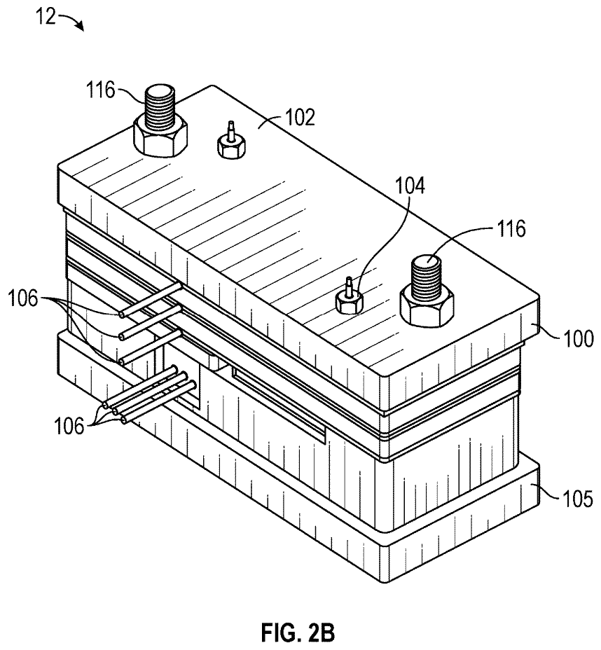

The invention relates to a flow battery (FB) performance diagnostic device capable of executing multiple modes of electrochemical and electronic analysis. Small amounts of fluid are pumped through the hardware to continuously measure FB characteristics. The invention includes a multi-channel battery analyzer including one or more measurement units and accompanying pluggable flow capsules, having the ability to run multiple measurements simultaneously. FIG. 2A is a schematic, in accordance with certain embodiments of the invention, illustrating a FB (1) and multiple portable flow capsules (12) strategically placed throughout the FB (1) to transmit. e.g., by wire or wirelessly, data to a central control hub (13). The control hub (13) includes a multi-channel battery analyzer (14) and a computer (15). Software provides high-throughput data analytics to pinpoint deficiencies and provide a complete analysis of system-wide performance. The invention provides diagnostics needed to reduce the cost of operating FBs and to accelerate the discovery and optimization of materials for FBs.

FIG. 2B is a schematic, in accordance with certain embodiments of the invention, illustrating a detail view of the portable flow capsules (12) shown in FIG. 2A, that include an upper compression plate (100), a flow path inlet 1 (102), a flow path inlet 2 (104), and a lower compression plate (105). The flow path inlets 1 and 2 (102, 104) serve as the inlets for entry of fluid into the portable flow capsules (12). Also shown in FIG. 2B are electrical connections 106, which serve to carry charge to and from the internal electrodes.

Each of the portable flow capsules (12) includes two flow channels, i.e., a positive flow channel and a negative flow channel, on either side of a separator, e.g., a semi-permeable separator. The positive flow channel accommodates one or more positive electrodes and the negative flow channel accommodates one or more negative electrodes, wherein the electrodes are responsible for injecting or extracting electric charge. One or more fluid pumps conveys fluid through each of the portable flow capsules (12), and in some embodiments the pump or pumps are internal to the capsule (12). In addition, in certain embodiments, each of the portable flow capsules (12) is sealed against the external atmosphere, such as with an outer casing that also provides structure to the portable flow capsules (12). Each of the portable flow capsules (12) is capable of being disassembled and reassembled such that the materials to be analyzed (i.e., fluid, electrodes, separators) are replaceable.

FIG. 2C is a schematic, in accordance with certain embodiments of the invention, illustrating the components that compose the portable flow capsules (12) as shown in FIG. 2A. The components include the lower compression plate (105) having an exterior surface and an interior surface. The exterior surface forms an outer surface of the portable flow capsules (12); the interior surface is in contact with a pump holder (112), which is in contact with two pumps (114). As used herein, “in contact with” includes one component being pressed or compressed with another component and “connected to” includes being in contact with or the use of one or more intermediary components and/or one or more fasteners, e.g., bolts and nuts, to join or link one component to another component. In certain embodiments, the portable flow capsules (12) include only one pump. As shown in FIG. 2C, there are bolts (116) that connect and/or fasten the lower compression plate (105) to the pump holder (112). In certain embodiments, the bolts (116) pass through holes formed in the plates and flow channels illustrated in FIG. 2C to connect together these components in a stacked configuration as shown in FIG. 2C. Connected to the pump holder (112) is a spacer plate (118) and in contact with the spacer plate (118) is a spacer gasket (120). A negative electrode plate (122) is in contact with the spacer gasket (120); the negative electrode plate (122) includes a negative electrode (124) in contact therewith. A negative flow channel plate (126) is in contact with a lower separator plate (128); as shown in FIG. 2C, a lower surface of the negative flow channel plate (126) is in contact with the negative electrode plate (122) and the upper surface of the negative flow channel plate (126) is in contact with the lower separator plate (128). A positive flow channel plate (132) is positioned between an upper separator plate (130) and an positive electrode plate (134); as shown in FIG. 2C, a lower surface of the positive flow channel plate (132) is in contact with the upper separator plate (130), and an upper surface of the positive flow channel plate (132) is in contact with the positive electrode plate (134), the positive electrode plate (134) includes a positive electrode (136). An injection plate (138) is in contact with the positive electrode plate (134). A lower surface of the upper compression plate (100) is in contact with the injection plate (138), and an exterior surface of the upper compression plate (100) serves as an outer surface of the portable flow capsules (12).

In certain embodiments, the portable flow capsules (12) include the lower compression plate (105) connected to the one or more pumps (114), the negative electrode connected to the negative flow channel plate (126), the positive electrode (136) connected to the positive flow channel plate (132), the negative and positive flow channel plates connected to a separator, e.g., such that the separator is “sandwiched” between the negative and positive flow channels, and an upper compression plate (100) having inserted therein flow path inlets (102, 104).

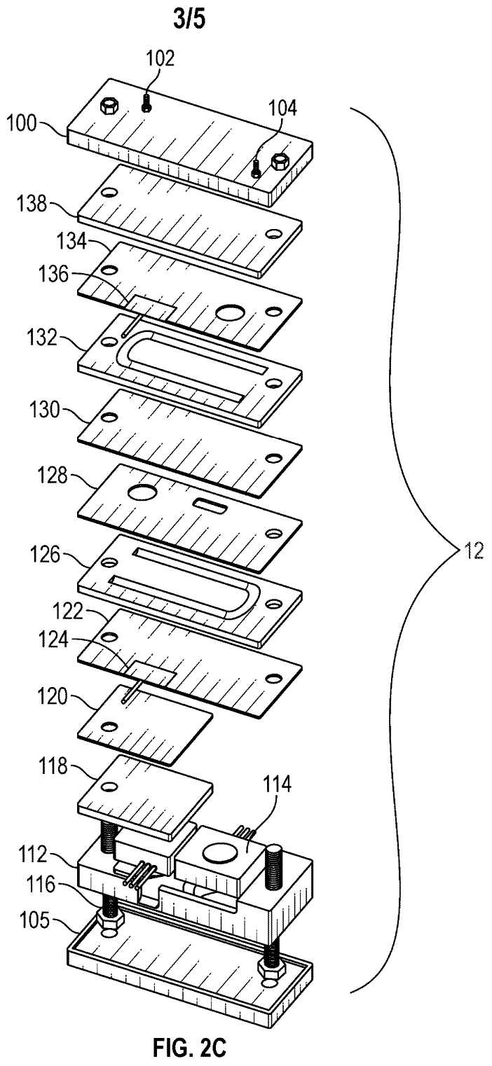

FIG. 3 is a schematic illustrating a multi-channel battery analyzer (14) according to certain embodiments of the invention. As illustrated in FIG. 3, the battery analyzer (14) includes one or more measurement units (16) and the multiple pluggable flow capsules (18) that are physically and electrically connected to, e.g., plugged or inserted into one or more holes or apertures (17), the one or more measurement units (16). The size and dimensions of the measurement units (16) can vary widely and are not limiting. In certain embodiments, the dimensions of the one or more measurement units (16) includes a height of 3 feet, width of 2 feet, and depth of 1 foot. In addition, the size and dimensions of the pluggable flow capsules (18) and the portable flow capsules can vary and are not limiting. In certain embodiments, the pluggable flow capsules (18) and portable flow capsules (12) are 3 inches by 2 inches by 1 inch. The flow capsules according to the invention have a size that is substantially smaller than traditional or conventional flow cells known in the art.

The pluggable flow capsules (18) function in multiple experimental configurations based on reconfigurable electrical connections that enable measurements of various types of electrical signals. The FB and pluggable flow capsules (18) accommodate fluid that (1) is flowable and (2) contains materials that accept and deliver electric charge. The pluggable flow capsules (18) have an internal volume from about 0.1 mL to about 10 mL in total volume per capsule and in certain embodiments, the internal volume is from about 0.1 mL to about 1 mL or about 1 mL. The term “internal volume” means the integral fluid capacity of each of the pluggable flow capsules.

Each of the pluggable flow capsules (18) includes two flow channels, i.e., a positive flow channel and a negative flow channel, on either side of a separator, e.g., a semi-permeable separator. The positive flow channel accommodates one or more positive electrodes and the negative flow channel accommodates one or more negative electrodes, wherein the electrodes are responsible for injecting or extracting electric charge. One or more fluid pumps conveys fluid through each of the pluggable flow capsules (18), and in some embodiments the pump or pumps are internal to the capsule (18). In addition, in certain embodiments, each of the pluggable flow capsules (18) is sealed against the external atmosphere, such as with an outer casing that also provides structure to the pluggable flow capsules (18).

In certain embodiments, the pluggable flow capsules (18) include a negative electrode connected to a negative flow path, a positive electrode connected to a positive flow path, the negative and positive flow paths connected to a separator, e.g., such that the separator is “sandwiched” between the negative and positive flow paths, wherein the electrodes are responsible for injecting or extracting electric charge.

Each of the pluggable flow capsules (18) is capable of being disassembled and reassembled such that the materials to be analyzed (i.e., fluid, electrodes, separators) are replaceable. The multi-channel battery analyzer (14) includes one or more measurement units (16) into which the battery capsules (18) connect, as well as computer software (15) to control the measurement unit (16). The unit (16) contains electrical components that enable electrochemical measurements to be performed by measuring or modulating the electric potential difference and the electric current flow between electrodes in each of the pluggable flow capsules (18).

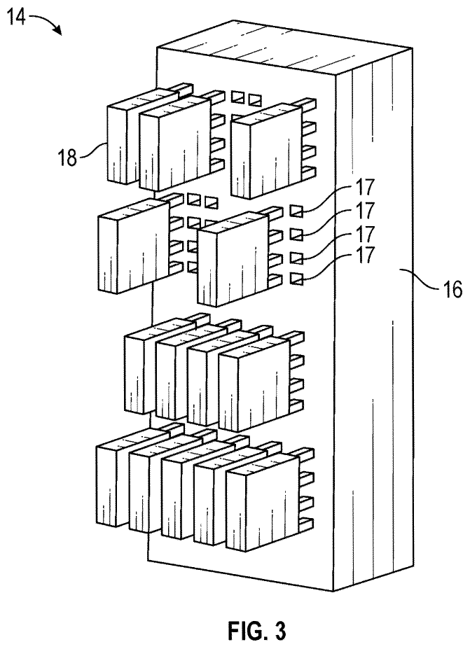

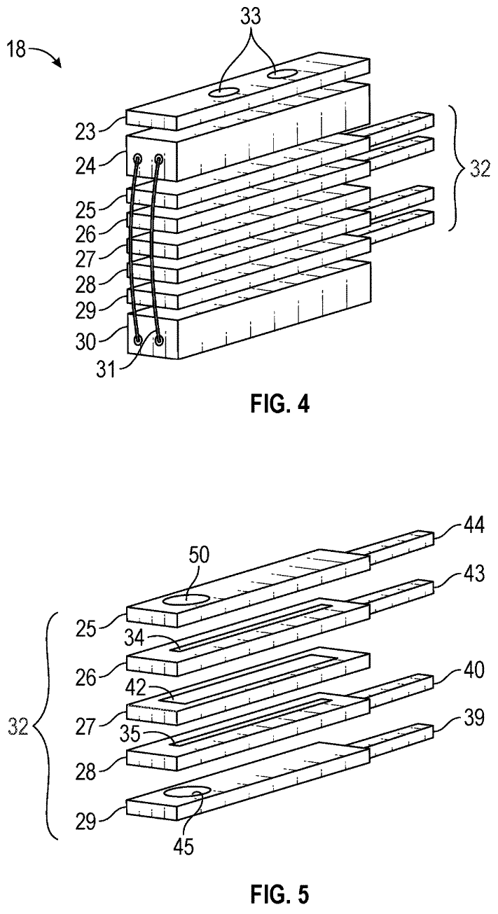

FIG. 4 is a schematic illustrating a detail view of a configuration for each of the pluggable flow capsules (18), as illustrated in FIG. 3, according to certain embodiments of the invention. As shown in FIG. 4, the pluggable flow capsules (18) have a stacked configuration. In certain embodiments, the capsules (18) include a capsule outer casing that provides structure to the pluggable flow capsules (18). As shown in FIG. 4, an outer plate (23) is a rectangular prism. The shape of the outer plate (23) can vary and is not limiting. The outer plate (23) provides an exterior surface of the pluggable flow capsules (18). As shown in FIG. 4, in contact with the outer plate (23) is an fluid reservoir (24) having an upper surface and a lower surface. The fluid reservoir (24) functions to store fluid and is optional; accordingly, in certain embodiments of the invention, the pluggable flow capsules (18) do not include the fluid reservoir (24). In certain embodiments, the positive and negative flow channel plates (26) and (28), respectively, serve as the fluid reservoir. As shown in FIG. 4, the interior surface of the outer plate (23) is in contact with the upper surface of the reservoir (24). Also in contact with the reservoir (24) is a positive electrode plate (25) having an upper surface and a lower surface. As shown in FIG. 4, the lower surface of reservoir (24) is in contact with the upper surface of the positive electrode plate (25). In certain embodiments, wherein a reservoir (24) is not included in the pluggable flow capsules (18), the interior surface of the outer plate (23) is in contact with the upper surface of the positive electrode plate (25). Also in contact with the positive electrode plate (25) is positive flow channel plate (26), having an upper surface and a lower surface. As shown in FIG. 4, the lower surface of the positive electrode plate (25) is in contact with the upper surface of the positive flow channel plate (26). Also in contact with the positive flow channel plate (26) is a separator plate (27) having an upper surface and a lower surface. As shown in FIG. 4, the upper surface of separator plate (27) is in contact with the lower surface of the positive flow channel plate (26). Also in contact with the separator plate (27) is a negative flow channel plate (28) having an upper surface and a lower surface. The lower surface of the separator plate (27) is in contact with the upper surface of the negative flow channel plate (28). The separator plate (27) includes a separator (42), as shown in FIG. 5, that is constructed from a wide variety of materials, such as, but not limited to (1) a polymer with a hydrocarbon backbone, such as, polyethylene or polypropylene, (2) a polymer derived from fluorinated hydrocarbons, such as, polytetrafluoroethylene, (3) an inorganic solid or mineral, such as, silica, alumina, zirconia, or any of various clays, and (4) composites containing any of the materials 1-3. In certain embodiments the separator (42) is a semi-permeable separator. Also in contact with the negative flow channel plate (28) is a negative electrode plate (29), having an upper surface and a lower surface. As shown in FIG. 4, the lower surface of the negative flow channel plate (28) is in contact with the upper surface of the negative electrode plate (29). Also in contact with the negative electrode plate (29) is a pump (30), having an upper surface and a lower surface. As shown in FIG. 4, the lower surface of the negative electrode plate (29) is in contact with the upper surface of the pump (30). In certain embodiments the pump (30) can be two separate pumps, one for each flow path, or one pump with two channels. The lower surface of the pump (30) serves as an outer surface that provides structure to the battery capsules (18). In certain embodiments, the pump (30) is a miniature diaphragm pump. In certain embodiments, the pump (3) is encased in a holder, such as, but not limited to a 3D printed holder, that provides structural support. Also shown in FIG. 4 is pump tubing (31), which serves to connect the pump (30) to the electrolyte reservoir (24), and electrical leads (32) that connect the battery capsules (18) to the measurement unit (16). In addition, a porous fluid injection site (33) is formed on the outer surface of the plate (23), which is penetrable by a needle to fill the electrolyte reservoir (24) or to provide electrolyte to the positive and negative flow channel plates (26) and (28), respectively. In certain embodiments, wherein the electrolyte reservoir (24) is not included in the pluggable flow capsules (18), the pump tubing (31) is not required and accordingly, is not present in the capsules (18). Additionally, in certain embodiments, each of the pluggable flow capsules (18) includes a casing or holder that encompasses and/or holds the stacked components identified in FIG. 4.

FIG. 5 is a schematic illustrating a detailed view of the electrodes and electrical leads as shown in FIG. 4. In FIG. 5, the stacked electrodes and electrical leads are shown in a capsule structure (36). Shown in FIG. 5 are electrical leads (39), (40), (43) and (44). The negative electrode plate (29) as shown in FIG. 4 includes a negative electrical lead (39). The negative flow channel plate (28) as shown in FIG. 4 includes a reference electrode 2 electrical lead (40), which serves to provide a comparable standard voltage to perform electrochemical analysis of the negative electrolyte. The positive flow channel plate (26) as shown in FIG. 4 includes a reference electrode 1 electrical lead (43), which serves to provide a comparable standard voltage to perform electrochemical analysis of the positive electrolyte. The positive electrode plate (25) as shown in FIG. 4 includes a positive electrical lead (44), which serves to change electrolyte state of charge composition. A separator (42) is shown within the separator plate (27) (as shown in FIG. 4). A positive flow channel and reference electrode 1 (34) is shown for the positive flow channel plate (26) wherein positive electrolyte travels therethrough, and a negative flow channel and reference electrode 2 (35) is shown for the negative flow channel plate (28) wherein negative electrolyte travels therethrough. FIG. 5 also shows a negative electrode (45) and a positive electrode 50.

The invention is specifically designed to support multiple simultaneous measurements of the chemical and electrical properties of flowable electrolytes without the need to couple together a set of independent analytical apparatus. The properties measured are of direct relevance in the field of electrochemical energy storage and, in particular, for the emerging technology area of redox flow batteries. These properties (electrochemical properties) include, but are not limited to: thermodynamics and kinetics of charge transfer to/from electrolytes; long-term stability of electrolytes; porosity and permeability of separators; catalytic properties of electrode materials; and long-term stability of fluids, electrodes, and separators.

The invention includes at least one of the following novel and/or distinctive features:
Small: the flow capsule is approximately the size of a cassette tape, and it will hold from about 0.1 mL to about 10 mL in fluid volume;
Flowable: the flow capsule accommodates fluid, which is inserted into the capsule through flow path inlet(s) or injection site(s) by the user and pumped through internal flow channels during testing;
Integrated: fluid storage chambers, e.g., reservoirs, flow pump(s), and all battery components are internal to the capsule;
Reconfigurable: the flow capsule is structured to be disassembled, and all active materials (electrodes, fluids, and separators) are replaceable;
Flexible: the flow capsule executes multiple analytical functions based on its physical configuration and the electrical signals that are used;
Multi-channel: multiple flow capsules are plugged into the measurement unit, and the associated electrical hardware and software accommodate measurements on multiple flow capsules at the same time; and
Hermetic: the flow capsule is closed to external atmosphere such that reactive materials stored inside are not exposed to air.

The portable flow capsules are placed at multiple points in the FB flow path and they are connected, e.g., by a wire or wirelessly, with the hub. The hub provides the analytics to inform FB engineers about system-wide performance. There are two intended uses for the flow capsules. The first is high-throughput materials screening for researchers to discover new materials exhibiting favorable physical properties for use in FBs. Materials screening is currently performed using FB hardware lacking one or more of the novel/distinctive features described above. However, these apparatus are costly and limit the speed of discovery. Therefore, high-throughput testing with improved flow capsules and a comprehensive testing platform will reduce these costs and accelerate FB materials discovery. The second use for flow capsules is performance diagnostics of operational FBs to support improved maintenance and longevity. Significant time and costs are spent diagnosing and troubleshooting FB system failures. For example, it is common to obtain samples from electrolyte tanks in the field and transport samples to an external laboratory for diagnostics. This approach results in time delays and potential misdiagnosis of problems. The portable flow capsules strategically placed within the flow loop work together to pinpoint system weaknesses in real-time and provide assessments to FB manufacturers to quickly identify operational instabilities and plan battery maintenance.

It should be understood and realized that the embodiments described herein are for illustrative purposes only and that various modifications or changes in light thereof will be suggested to persons skilled in the art and are to be included within the spirit and purview of this application.

1. One or more flow capsules (12, 18), comprising:
a semi-permeable separator (27) having a first exterior side and a second exterior side;
a first flow channel plate (26) having an interior wall, positioned in a stacked configuration along the first exterior side of the separator plate; (27)
a second flow channel plate (28) having an interior wall, positioned in a stacked configuration along the second exterior side of the separator plate (27); and
a first electrode plate (25) and second electrode plate (29) positioned correspondingly in a stacked configuration along the interior wall of each of the first and second flow channel plates (26, 28), respectively,
wherein the first and second electrode plates (25, 27) inject or extract electric charge, and
wherein the total internal volume of fluid contained or stored in the flow capsule (12, 18) is from about 0.1 mL to about 10 mL.

2. The one or more flow capsules (12, 18) of claim 1, further comprising an outer casing to provide structure.

3. The one or more flow capsules (12, 18) of claim 2, wherein the casing seals against an external environment.

4. The one or more flow capsules (12, 18) of claim 1, further comprising at least one of reservoir (24) and a pump (30).

5. The one or more flow capsules (12, 18) of claim 1, wherein the one or more flow capsules is structured to be disassembled and reassembled to replace one or more of the fluid, the first and second electrode plates (25, 29), and the semi-permeable separator (42).

6. The one or more flow capsules (12, 18) of claim 1, wherein the total volume of fluid is from about 0.1 mL to about 1 mL.

7. The one or more flow capsules (12, 18) of claim 1, wherein the one or more flow capsules are structured to execute multiple analytical functions.

8. The one or more flow capsules (12, 18) of claim 1, wherein the one or more flow capsules are structured to correspondingly plug into multiple measurement units (16) to provide multiple measurements simultaneously.

9. The one or more flow capsules (12, 18) of claim 6, wherein the total volume of fluid is about 1 mL.

10. The one or more flow capsules (12, 18) of claim 1, wherein the dimensions are 3 inch by 2 inch by 1 inch.

11. A method of obtaining multiple measurements simultaneously, comprising:
employing an integrated multi-channel battery analyzer (14), comprising one or more measurement units (16); and
connecting physically and electrically to the one or more measurement units, one or more pluggable flow capsules (18) being in a stacked configuration comprising:
a separator having an upper surface and a lower surface;
a positive flow channel plate (26) having an upper surface and a lower surface, the lower surface of the positive flow channel connected to the upper surface of the separator plate (27);
a negative flow channel plate (28) having an upper surface and a lower surface, the upper surface of the negative flow channel connected to the lower surface of the separator plate (27); and
a positive electrode plate (25) having an upper surface and a lower surface, the lower surface of the positive electrode connected to the upper surface of the positive flow channel plate (26); and
a negative electrode plate (29) having an upper surface and a lower surface, the upper surface of the negative electrode connected to the lower surface of the negative flow channel plate (28).

12. A method of measuring electro-chemical properties of a flow battery, comprising:
obtaining a flow battery;
strategically placing multiple portable flow capsules (12) throughout the flow battery; and
transmitting data from the flow capsules (12) to a central control hub (13), comprising:
a computer (15); and
a multi-channel battery analyzer (14):
one or more measurement units (16); and the multiple portable flow capsules (12) being in a stacked configuration, comprising;
a separator (128, 130) having an upper surface and a lower surface;
a positive flow channel (132) having an upper surface and a lower surface, the lower surface of the positive flow channel connected to the upper surface of the separator (130);
a negative flow channel (126) having an upper surface and a lower surface, the upper surface of the negative flow channel connected to the lower surface of the separator (128); and
a positive electrode (136) having an upper surface and a lower surface, the lower surface of the positive electrode connected to the upper surface of the positive flow channel (132); and
a negative electrode (124) having an upper surface and a lower surface, the upper surface of the negative electrode connected to the lower surface of the negative flow channel (126),
wherein the positive and negative electrodes inject and extract electric charge, respectively, and
wherein, the computer (21) comprises software to control the one or more measurement units, provide high-throughput data analytics to pinpoint deficiencies and an analysis of the flow battery performance.

13. An integrated flow battery device, comprising:
one or more pluggable flow capsules (18), comprising:
a separator plate (27) having a first exterior side and a second exterior side;
a first flow channel plate (26) having an interior wall, positioned in a stacked configuration along the first exterior side of the separator plate (27);
a second flow channel (28) plate having an interior wall, positioned in a stacked configuration along the second exterior side of the separator plate (27); and
a first electrode plate (25) and second electrode plate (29) positioned correspondingly in a stacked configuration along the interior wall of each of the first and second flow channel plates (26, 28), respectively,
wherein the first and second electrode plates (25, 29) inject or extract electric charge, and
wherein the internal volume of fluid contained or stored in the pluggable flow capsule (18) is from about 0.1 mL to about 10 mL;
a multi-channel battery analyzer (14), comprising:
one or more measurement units (16) into which the one or more pluggable flow capsules (18) correspondingly connects physically and electrically;
software (15) to control the one or more measurement units (16); and
electrical components (32) to measure electrochemical properties; and
a fluid accommodated by the first and second flow channels (26, 28) in the one or more pluggable flow capsules to accept and deliver the electric charge to an external circuit.

14. The integrated flow battery device of claim 13, wherein the electrochemical measurements comprise measurement and/or modulation of electric potential difference and electric current flow between electrodes in the one or more pluggable flow capsules (18).

15. The integrated flow battery device of claim 13, wherein the one or more pluggable flow capsules (18) when correspondingly plugged into the one or more measurement units (16), provide multiple measurements simultaneously.

16. The integrated flow battery device of claim 13, wherein the total internal volume of fluid of each of the one or more pluggable flow capsules (18) is from about 0.1 mL to about 1 mL.

17. The integrated flow battery device of claim 13, wherein the total internal volume of fluid of each of the one or more pluggable flow capsules (18) is about 1 mL.
